(19) United States
(12) Patent Application Publication
(10) Pub. No.: US 2014/0110261 A1
(43) Pub. Date: Apr. 24, 2014

(54) CHIP FOR ELECTROPHORESIS AND METHOD FOR PRODUCING SAME

(71) Applicants: Hiroshi Ohki, Osaka-shi (JP); Yuji Maruo, Osaka-shi (JP); Yutaka Unuma, Osaka-shi (JP)

(72) Inventors: Hiroshi Ohki, Osaka-shi (JP); Yuji Maruo, Osaka-shi (JP); Yutaka Unuma, Osaka-shi (JP)

(73) Assignee: SHARP KABUSHIKI KAISHA, Osaka-shi, Osaka (JP)

(21) Appl. No.: 14/127,614

(22) PCT Filed: Jun. 19, 2012
(86) PCT No.: PCT/JP2012/065664

§ 371 Date: Dec. 19, 2013

(30) Foreign Application Priority Data
Jun. 21, 2011 (JP) 2011-137849

(51) Int. Cl. B01D 57/02; B05D 1/36

(52) U.S. Cl. CPC B01D 57/02; B05D 1/36
USPC 204/606; 427/58

(57) ABSTRACT

A chip (10) for electrophoresis is provided, the chip including a gel (9) composed of a polymer prepared by polymerizing a monomer, and a support (1) configured to support the gel (9). In the chip (10) for electrophoresis, a surface of the support (1) in contact with the gel (9) is covered with a surface treatment compound (4) containing the monomer or a derivative of the monomer.

### TECHNICAL FIELD

The present invention relates to a chip for electrophoresis to perform the separation of a biological sample and a method for producing the chip.

### BACKGROUND ART

Electrophoresis is a phenomenon in which charged particles or molecules migrate in an electric field, and in particular, is an important technique for separating DNA, protein, and so forth in molecular biology and biochemistry. In recent years, proteome analysis has been attracting attention as post-genomic study. Proteome analysis indicates the large-scale analytical study of the structures and functions of proteins. To perform proteome analysis, it is usually necessary to separate proteins contained in a sample into individual proteins. At this time, two-dimensional electrophoresis is one of the commonly used techniques.

Two-dimensional electrophoresis is a technique for two-dimensionally separating proteins by two-stage electrophoresis. Commonly, in the first dimension, proteins are separated by isoelectric focusing (IEF) according to their isoelectric points. In the second dimension, proteins are separated by sodium dodecyl sulfate-polyacrylamide gel electrophoresis (SDS-PAGE) according to their molecular weights. The two-dimensional electrophoresis has very high resolution, so it is possible to separate several thousands or more of proteins into spots.

In IEF in the first dimension, an immobilized pH gradient (IPG) excellent in reproducibility and resolution is commonly employed with an immobilized pH gradient gel (IPG gel). As a gel used for SDS-PAGE in the second dimension, an agarose gel or a polyacrylamide gel is commonly used. In the case of using the polyacrylamide gel, a homogeneous gel in which an acrylamide solution is uniform is commonly used. In the case where a wide molecular weight range needs to be observed, a gradient gel that has a gradient from high to low concentrations of an acrylamide solution may be used.

Each of the IPG gel and the SDS-PAGE gel may be formed by coating on, for example, plastic or glass or by pouring a gel solution into a mold (for example, a gap between glass substrates facing each other with a spacer).

For example, PTL 2 discloses an electrophoresis cell formed by performing hydrophilization centering on a channel portion, charging a gel material, gelling the gel material, and a method for producing the same. According to PTL 2, an electrophoresis cell having, for example, no leakage of a sample, no reduction in resolution, and no reduction in signal-to-noise (SN) ratio when optical detection is performed can be produced by, after gelation, covering a surface of a substrate with a coating film composed of a cross-linked polymer.

In recent years, however, the frequency of use of gel electrophoresis has been significantly increased because electrophoresis is used for genomic analysis of animals and plants. Thus, a demand for a technique for producing a uniform gel plate with good productivity has been increasing.

PTL 1 discloses an electrophoresis gel plate by an ink jet method and a method for producing the same. According to PTL 1, it is possible to provide an electrophoresis gel plate capable of simultaneously treating a large number of samples under the same conditions and form a plurality of gel formation regions.

### CITATION LIST

### Patent Literature

PTL 1: Japanese Unexamined Patent Application Publication No. 2004-77393 (publication date: Mar. 11, 2004)

PTL 2: Japanese Unexamined Patent Application Publication No. 2000-214132 (publication date: Aug. 4, 2000)

### SUMMARY OF INVENTION

### Technical Problem

However, in a chip for electrophoresis, the chip including a gel and a support therefor, if an affinity or adhesion between the gel and the support is low, the gel is not appropriately held, in some cases. In particular, as described in PTL 1, in the case where a gel solution containing gel particles dispersed therein is ejected onto a flat plate to produce a gel plate, it is difficult to form a gel at a predetermined position. Furthermore, the gel may be detached from the plate. PTL 2 states that a gel is covered with the coating film composed of a cross-linked polymer. To form the coating film, however, complicated steps are needed. PTL 2 also describes the hydrophilization of the support. However, in the case of the hydrophilization, the affinity and the adhesion are insufficient.

The present invention has been accomplished in light of the foregoing problems. It is a main object of the present invention to provide in a chip for electrophoresis, a technique for holding a gel easily and appropriately.

### Solution to Problem

To solve the foregoing problems, a chip for electrophoresis according to the present invention includes a gel composed of a polymer prepared by polymerizing a monomer; and a support configured to support the gel, in which a surface of the support in contact with the gel is covered with a surface treatment compound containing the monomer or a derivative of the monomer.

According to the foregoing structure, it is possible to increase the adhesion between the gel and the support and improve the affinity between the gel and the support. That is, by covering the support with the monomer or a derivative of the monomer contained in the gel, the physical adhesion between the gel and the support can be increased, compared with the case where the support is just hydrophilized, and the affinity between the gel and the support can be improved, compared with the case where the support is just hydrophilized. This inhibits the detachment of the gel from the support, thus easily forming the gel in a predetermined region of the support.

In addition, for example, a covalent bond may be formed between the surface treatment compound and the gel to produce very high adhesion. Furthermore, for example, a monomer deposited on the support may be subjected to polymerization triggered by the surface treatment compound that has been radicalized, thereby suitably forming the gel.

According to the foregoing structure, the chip for electrophoresis holds the gel easily and appropriately as described above.

A method for producing a chip for electrophoresis according to the present invention, the chip for electrophoresis including a gel composed of a polymer prepared by polymerizing a monomer, and a support configured to support the gel, includes a covering step of covering at least part of a surface of the support with a surface treatment compound containing the monomer or a derivative of the monomer, and a gel formation step of forming the gel on a covered region of the surface of the support.

According to the foregoing configuration, it is possible to increase the adhesion between the gel and the support and improve the affinity between the gel and the support. That is, by covering the support with the monomer or the derivative of the monomer contained in the gel, the physical adhesion between the gel and the support can be increased, compared with the case where the support is just hydrophilized, and the affinity between the gel and the support can be improved, compared with the case where the support is just hydrophilized. This inhibits the detachment of the gel from the support, thus easily forming the gel in a predetermined region of the support. In addition, for example, a covalent bond may be formed between the surface treatment compound and the gel to produce very high adhesion. According to the foregoing configuration, as described above, it is possible to suitably produce the chip for electrophoresis, the chip holding the gel easily and appropriately.

### Advantageous Effects of Invention

In the chip, having the forgoing structure, for electrophoresis according to the present invention, it is possible to increase the adhesion between the gel and the support and improve the affinity between the gel and the support. Thus, in the chip for electrophoresis, the gel can be held easily and appropriately.

### BRIEF DESCRIPTION OF DRAWINGS

FIG. 1 is a schematic view illustrating the outline structure of a chip for electrophoresis according to an embodiment of the present invention.

FIG. 2 illustrates schematic views of outline structures of supports according to embodiments of the present invention, (a) illustrates the outline structure of a film-like support, and (b) illustrates the outline structure of the plate-shaped support.

FIG. 3 is a schematic view illustrating the outline structure of a support covered with a surface treatment compound according to an embodiment of the present invention.

FIG. 4 depicts cross-sectional views illustrating steps in a method for producing a chip for electrophoresis according to an embodiment of the present invention.

### DESCRIPTION OF EMBODIMENTS

Embodiments of the present invention will be described in detail below with reference to the drawings.

### (Chip for Electrophoresis)

The present invention provides a chip for electrophoresis. In this specification, the chip for electrophoresis denotes an article in which a gel for electrophoresis is provided on a support and which can be used for gel electrophoresis. A substance to be separated by electrophoresis with the chip for electrophoresis according to the present invention may be a substance to be separated or analyzed by electrophoresis and transfer. For example, a preparation from a biological material (for example, a whole organism, a body fluid, a cell strain, a tissue culture, or a piece of tissue) may be preferably used. A polypeptide or polynucleotide may be more preferably used.

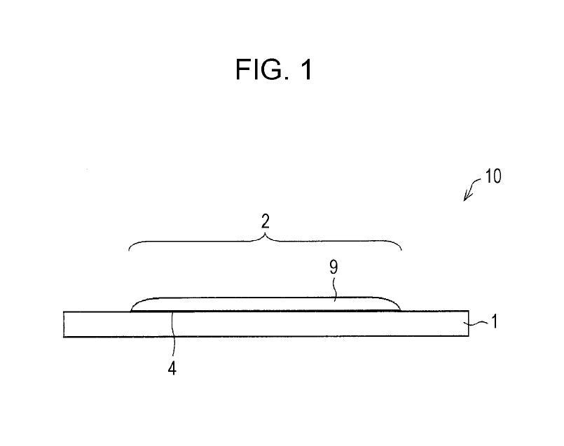

FIG. 1 is a schematic view illustrating the outline structure of a chip 10 for electrophoresis according to an embodiment of the present invention. The chip 10 for electrophoresis includes a gel 9 composed of a polymer prepared by polymerizing a monomer; and a substrate (support) 1 configured to support the gel 9, in which a surface of the substrate 1 in contact with the gel 9 is covered with a surface treatment compound 4 containing the monomer or a derivative of the monomer.

The gel refers to a solid that does not have flowability because of a network structure formed by cross-linking due to the polymerization of a monomer. The derivative refers to an organic compound formed by modifying a monomer by the introduction or alteration of a functional group, the substitution of an atom, oxidation, reduction, or the like without a significant change in structure.

According to this embodiment, it is possible to increase the adhesion between the gel 9 and the substrate 1 and improve the affinity between the gel 9 and the substrate 1. That is, by covering the substrate 1 with a monomer or a derivative of the monomer contained in the gel 9, the physical adhesion between the gel 9 and the substrate 1 can be increased, compared with the case where the substrate 1 is just hydrophilized, and the affinity between the gel 9 and the substrate 1 can be improved, compared with the case where the substrate 1 is just hydrophilized. This inhibits the detachment of the gel 9 from the substrate 1, thus easily forming the gel 9 in a predetermined region of the substrate 1.

In addition, for example, a covalent bond may be formed between the surface treatment compound 4 and the gel 9 to produce very high adhesion. Furthermore, for example, a monomer deposited on the substrate 1 may be subjected to polymerization triggered by the surface treatment compound 4 that has been radicalized, thereby suitably forming the gel 9.

According to this embodiment described above, in the chip 10 for electrophoresis, the gel 9 can be easily and appropriately held. Details of components will be described below.

### (Substrate)

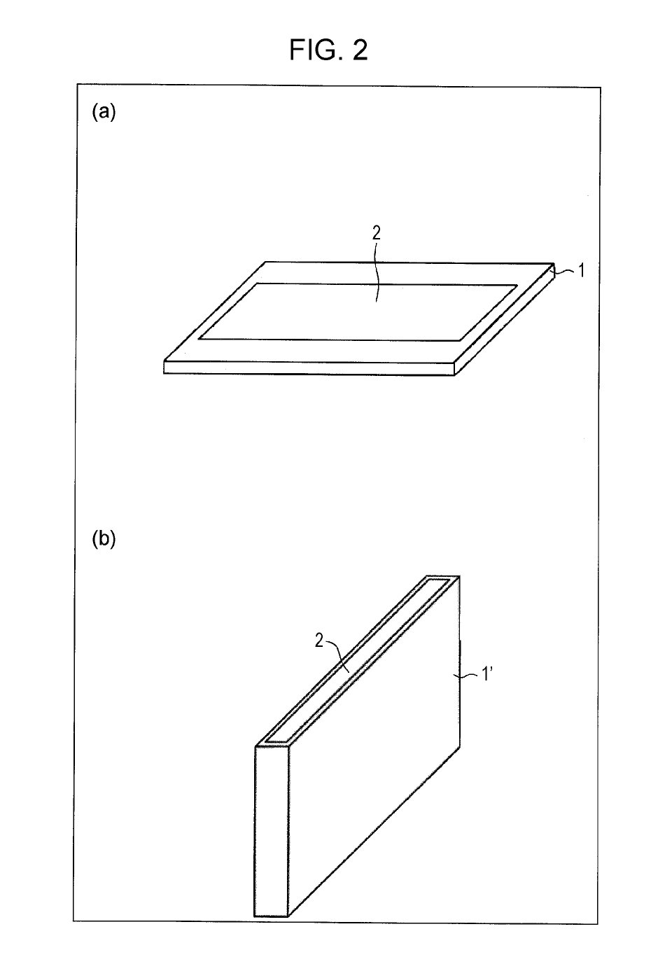

The substrate 1 is not particularly limited as long as it supports the gel. For example, as illustrated in FIG. 2, a film-like substrate and a plate-shaped substrate may be used.

(a) of FIG. 2 is a schematic view illustrating the outline structure of a film-like support 1. Examples of a material for the film-like substrate 1 that may be used include, but are not limited to, polyester, such as polyethylene terephthalate (PET), polyethylene, polypropylene, and polyvinyl chloride. The thickness of the substrate 1 is not particularly limited and may be appropriately set, depending on application.

(b) of FIG. 2 is a schematic view illustrating the outline structure of a plate-shaped substrate 1′. Examples of a material for the plate-shaped substrate 1 include, but are not limited to, flat plates, such as acrylic plates composed of, for example, polymethyl methacrylate (PMMA), polycarbonate, polyvinyl chloride, polypropylene, glass, ceramics, and semiconductor substrates.

### (Gel Adhesion Region)

The substrate 1 preferably includes a gel adhesion region 2 where the gel 9 will be formed. For example, in the case where the substrate 1 has a film-like shape, the gel adhesion region 2 is preferably provided on a film surface of the substrate 1 as illustrated in (a) of FIG. 2. For example, in the case where the substrate 1 has a plate shape, the gel adhesion region 2 may be provided on a plate surface of the substrate 1. Alternatively, as illustrated in (b) of FIG. 2, the gel adhesion region 2 may be provided on a side surface of the substrate 1′. The gel adhesion region 2 may be provided on part of a surface of the substrate 1 or may be provided on the whole of a surface of the substrate 1.

The shape of the gel adhesion region 2 is not particularly limited and may be a shape appropriate for electrophoresis performed. Specifically, the shape of the gel adhesion region 2 may be in the form of a rectangle as illustrated in (a) of FIG. 2 or a strip as illustrated in (b) of FIG. 2.

For example, the gel adhesion region 2 may be formed by forming a mask so as to surround a region to be formed into the gel adhesion region 2 on a surface of the substrate 1 to be contact with the gel. As a simple method, a polyimide tape may be attached to the substrate 1 in a predetermined shape. Alternatively, a resist, a metal mask, or the like may be formed in a predetermined shape by photolithography. A masking technique is not particularly limited and may be appropriately selected, depending on application. In the case where the whole of a surface of the substrate 1 is formed into the gel adhesion region 2, there is no need for a masking process. Furthermore, known surface modification treatment other than masking may be used for the formation of the gel adhesion region 2.

The substrate 1 may have a structure in which a channel may be formed and in which the gel adhesion region 2 is provided on the bottom of the channel so as to be accommodated in the channel. Alternatively, as illustrated in FIG. 2, the gel adhesion region 2 may be provided in a portion having substantially the same height as its surroundings. Thus, the gel 9 is formed so as to protrude from the substrate 1. The formation of the gel 9 that protrudes from the substrate 1 facilitates the application of a sample to be subjected to electrophoresis and eliminates the need for the formation of the channel, thereby simplifying the structure of the substrate 1. Here, in the chip 10 for electrophoresis according to this embodiment of the present invention, the affinity and the amount of adhesion between the gel 9 and the substrate 1 are strong. Thus, although the gel 9 is formed so as to protrude from the substrate 1, the gel 9 can be appropriately held.

### (Gel)

As the gel 9, a gel used for two-dimensional electrophoresis may be used. Examples of the gel used for two-dimensional electrophoresis include agarose gels and polyacrylamide gels. In particular, polyacrylamide gels have recently been extensively used.

Examples of polyacrylamide gels include SDS-PAGE gels (gels used for the second dimension) composed of acrylamide/bisacrylamide; and IPG gels composed of acrylamide/bisacrylamide and acrylamide derivatives.

As an agarose gel, for example, a polysaccharide in which a D-galactose and 3,6-anhydro-L-galactose are alternately bound may be used. D-Galactose or 3,6-anhydro-L-galactose may be substituted with a substituent.

The gel 9 may appropriately contain, for example, a reagent and a buffer required to perform electrophoresis and a reagent for preservation.

### (Surface Treatment Compound)

The surface treatment compound 4 contains a monomer or a derivative of the monomer that is contained in a polymer of which the gel 9 is composed.

In the case where the gel 9 is a polyacrylamide gel, the main skeleton of the gel 9 is composed of acrylamide. Thus, acrylamide or a derivative having a chemical structure similar to acrylamide is used as the surface treatment compound 4, thereby providing the effect of this embodiment.

That is, preferred examples of the surface treatment compound 4 include, but are not limited to, vinyl compounds, such as acrylamide, acrylic acid, methacrylic acid, 2-hydroxyethyl acrylate, 2-hydroxyethyl methacrylic acid, N-vinyl-2-pyrrolidone, 2-(N,N-dimethylamino)ethyl acrylate, and 2-(N,N-dimethylamino)ethyl methacrylate. In particular, the surface treatment compound 4 preferably has a chemical structure represented by the structural formula CH₂═CH—CO(NR¹R²) (where R¹ and R² each independently represent any functional group). As the derivative of acrylamide, a compound having a basic structure represented by the structural formula CH₂═CHCONHR¹ (where R¹ represents, for example, a functional group, e.g., —CH₂CH₂SO₃H, —CHOHCOOH, —(CH₂)ₙCH₂COOH (n=1 to 3), —(CH₂)ₙC₄H₈ON (n=2 or 3), —(CH₂)ₙC₄H₈SN (n=2 or 3), —(CH₂)ₙNH₂ (n=2 or 3), —(CH₂)₃N(CH₂CH₃)₂, or —(CH₂)₃NH₃⁺) or the structural formula CH₂═CHCOC₄H₉N₂ is particularly preferred.

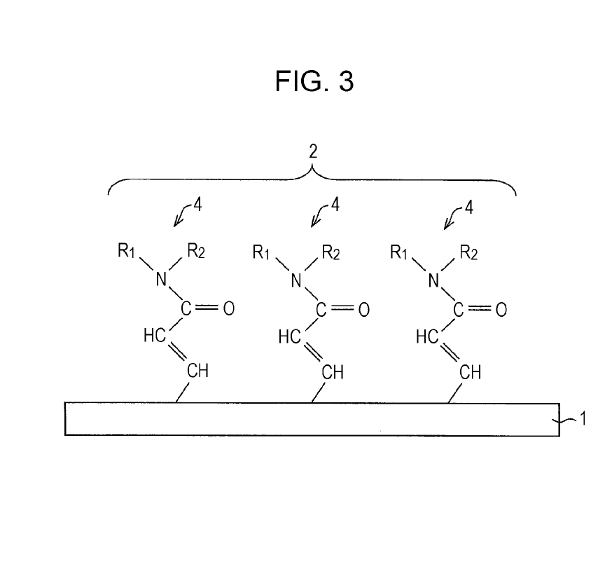

FIG. 3 is a schematic view illustrating the outline structure of the substrate 1 covered with the surface treatment compound 4 having a structure represented by the structural formula CH₂═CH—CO(NR¹R²). As illustrated in FIG. 3, the surface treatment compound 4 is provided on the gel adhesion region 2 of the substrate 1. As illustrated in FIG. 3, when the surface treatment compound 4 is fixed on the substrate, H may be eliminated from the acrylamide derivative (CH₂═CH—CO(NR¹R²)) into a base structure —CH═CH—CO(NR¹R²).

As described above, in the case where a polyacrylamide gel is used as the gel 9 and where a vinyl compound is used as the surface treatment compound 4, acrylamide contained in the gel 9 has a similar structure to the surface treatment compound 4, thus improving the affinity. Furthermore, the vinyl group of the vinyl compound is cleaved to form a radical. Acrylamide, which is contained in the polyacrylamide gel, is subjected to chain polymerization using the radical as a reaction center. Thereby, the surface treatment compound 4 and the gel 9 are covalently bonded and adhere tightly to each other.

In the case where the gel 9 is an agarose gel, the main skeleton of the gel 9 is composed of D-galactose and 3,6-anhydro-L-galactose. Thus, galactose, anhydrogalactose, or a derivative (for example, a monosaccharide) having a chemical structure similar to galactose or anhydrogalactose is effectively used as a surface treatment compound.

As described above, in the case where an agarose gel is used as the gel 9 and where a monosaccharide is used as the surface treatment compound 4, galactose contained in the gel 9 has a structure similar to the surface treatment compound 4, thus improving the affinity. Furthermore, a covalent bond is formed between a hydroxy group of the monosaccharide and a hydroxy group of the agarose gel by dehydration, so the surface treatment compound 4 and the gel 9 are covalently bonded and adhere tightly to each other.

A technique for providing the surface treatment compound 4 at a predetermined position of the substrate may be appropriately selected from wet processes, such as an ink jet method, a dipping method, a spin coating method, a silane coupling method, a screen printing method, and a Langmuir-Blodgett technique, and dry processes, such as an evaporation method and a plasma polymerization method and is not limited thereto.

### (Method for Producing Chip for Electrophoresis)

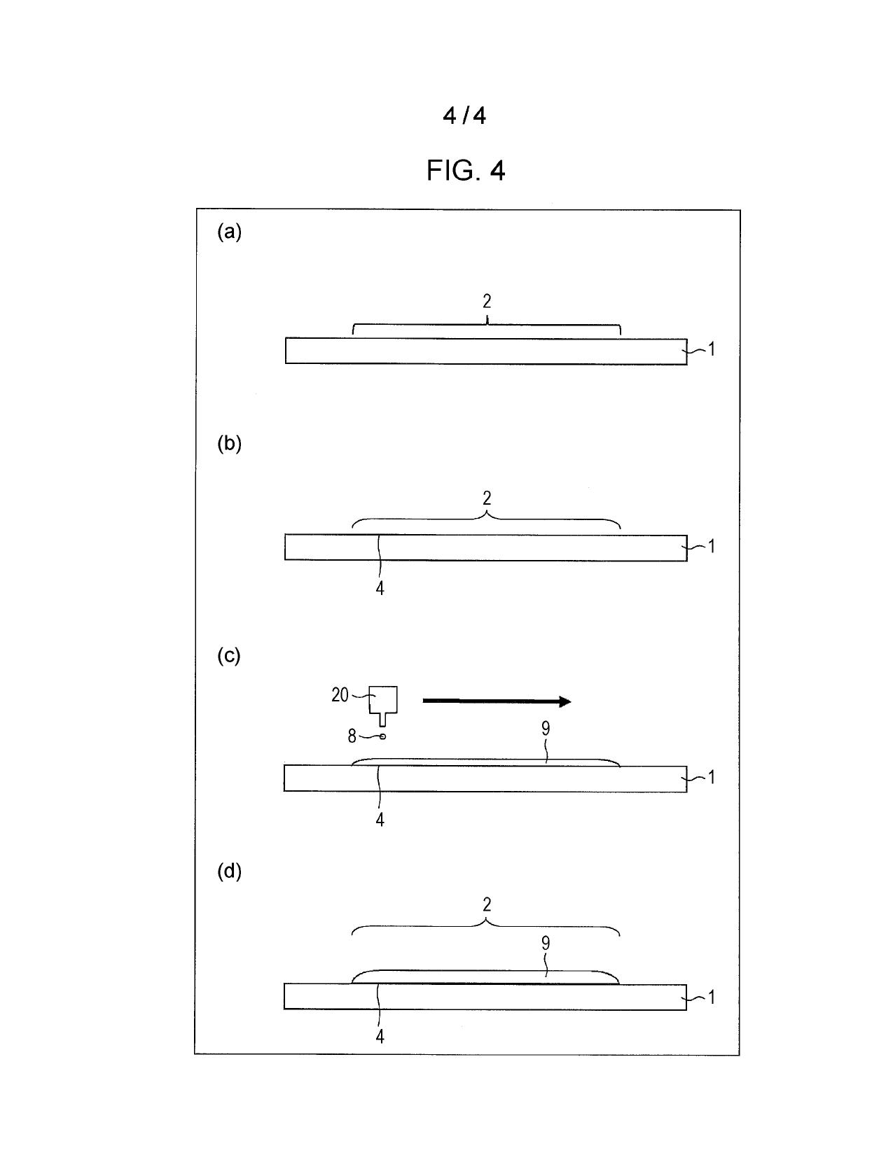

FIG. 4 depicts cross-sectional views illustrating steps in a method for producing the chip 10 for electrophoresis.

As illustrated in (a) of FIG. 4, the substrate 1 is prepared. As illustrated in (a) of FIG. 4, the gel adhesion region 2 is provided in advance on the substrate 1. With respect to a method for forming the gel adhesion region 2, the attachment of a masking tape, a resist, a metal mask formed by photolithography, or the like may be appropriately employed as described above. For example, in the case where a 70 mm×13 mm polyethylene terephthalate film is used as the substrate 1, the gel adhesion region 2 may be formed by attaching a polyimide tape having a 50 mm×2.4 mm cut pattern (window) formed with a laser beam machine or the like to the substrate 1.

As illustrated in (b) of FIG. 4, a thin film composed of the surface treatment compound 4 is formed on the gel adhesion region 2 of the substrate 1. As a method for forming the thin film composed of the surface treatment compound 4, for example, a method for forming a thin film of the surface treatment compound 4 by ejecting a solution of the surface treatment compound 4 onto the gel adhesion region 2 may be employed. It is preferred that a surface of the substrate 1 be chemically activated by oxygen plasma treatment before the ejection of the surface treatment compound 4. The ejection of the solution of the surface treatment compound 4 may be performed with an ink jet head, sprayer, or the like. Alternatively, the substrate 1 may be dipped into the solution of the surface treatment compound 4.

As a method for covering a surface of the substrate 1 with the surface treatment compound 4, graft polymerization may be employed. Covering by graft polymerization reduces variations in covering.

In addition, the method may be appropriately selected from wet processes, such as a spin coating method, a silane coupling method, a screen printing method, and a Langmuir-Blodgett technique, and dry processes, such as an evaporation method and a plasma polymerization method. Even in the cases of using these methods, it is possible to appropriately cover the surface of the substrate 1 with the surface treatment compound 4.

As illustrated in (c) of FIG. 4, the gel 9 is formed on the thin film composed of the surface treatment compound 4 (on the gel adhesion region 2). For example, in the case where a polyacrylamide gel is formed as the gel 9, for example, an acrylamide mixture solution (acrylamide+N,N′-methylenebisacrylamide), Tris-HCl buffer (Tris-HCl), ammonium persulfate (APS), or N,N,N′,N′-tetramethylphenylenediamine (TEMED) may be used as a gel formation solution 8. The acrylamide mixture solution is a mixed solution of acrylamide that forms the main skeleton of the gel 9 and N,N′-methylenebisacrylamide that cross-links the main skeleton of the gel 9. APS is a polymerization initiator for acrylamide. TEMED is a polymerization promoter. For example, in the case where an agarose gel is used as the gel 9, for example, a mixture of agarose and either TBE or a TAE buffer may be used as the gel formation solution 8.

A gradient gel having a concentration difference from high to low concentrations can be formed by ejecting minute droplets 6 of the gel formation solution 8 according to an ejection density difference pattern (gradient pattern) with an ink jet head (ink jet nozzle) 20 in a direction indicated by an arrow in (c) of FIG. 4. In addition, an immobilized pH gradient (IPG) gel can also be formed in the same way as above. In this case, a monomer and a buffer, which are contained in the gel, are mixed in a desired mixing ratio to form an acid gel formation solution and a basic gel formation solution. The use of a gradient pattern in which the high and low concentrations are interchanged enables the formation of the IPG gel.

The gel 9 need not be formed as a gradient gel and may be formed as a gel having a uniform concentration. The ink jet head 20 need not be used for the formation of the gel 9. Another method (for example, a method in which a frame surrounding the gel adhesion region 2 is arranged and the gel formation solution 8 is injected thereinto) may be employed.

Here, the gel adhesion region 2 is covered with the surface treatment compound 4 as described above and thus has a higher affinity for the gel 9 and the gel formation solution 8 than its surroundings. Hence, the gel 9 can be successfully formed in the gel adhesion region 2.

As illustrated in (d) of FIG. 4, the gel 9 is completed. In the case where the gel 9 is a polyacrylamide gel, the polyacrylamide gel is formed with APS and TEMED. By standing at room temperature (preferably 50° C.) in a nitrogen atmosphere for about 1 hour to about 3 hours, the gel 9 is completed. At this time, the surface treatment compound 4 is covalently bonded to the gel 9 to form a very strong bond. The reason for this is that the vinyl group of a vinyl compound of the surface treatment compound 4 is cleaved to from a radical and that acrylamides are subjected to chain polymerization using the radical as a reaction center.

Unlike the polyacrylamide gel, an agarose gel can be obtained by gelation due to hydrogen bonds. The gelation of agarose is caused by cross-linking of agarose molecules with hydrogen bonds. For example, agarose is melted by heating to about 60° C. and cooled to room temperature, so that gelation may be performed. In the case where the agarose gel is formed with an ink jet head, heating to about 60° C. is required. Thus, a heat-resistance ink jet head is preferably used.

In the case where the gel 9 is an agarose gel, standing leads to the completion of the gel 9. At this time, similarly, the surface treatment compound 4 is covalently bonded to the gel 9 to form a very strong bond. The reason for this is that the covalent bond is formed between a hydroxy group of a monosaccharide and a hydroxy group of the agarose gel by dehydration.

As described above, the gel 9 and the substrate 1 are tightly bonded together, thus inhibiting the detachment of the substrate 1 from the gel 9.

Impurities, such as an electrolyte and an unreacted monomer, are left in the gel 9, so washing is required, in some cases. In that case, shaking is preferably performed with, for example, deionized water or a solution of an electrolyte, such as an ampholyte. The shaking is preferably performed at room temperature for about 1 hour to 2 hours.

Ultimately, the gel 9 on the chip 10 for electrophoresis is dried and refrigerated (−20° C. or lower), thereby enabling long-term storage.

### SUMMARY

As described above, the chip for electrophoresis according to the present invention includes a gel composed of a polymer prepared by polymerizing a monomer, and a support configured to support the gel, in which a surface of the support in contact with the gel is covered with a surface treatment compound containing the monomer or a derivative of the monomer.

According to the foregoing structure, it is possible to increase the adhesion between the gel and the support and improve the affinity between the gel and the support. That is, by covering the support with the monomer or a derivative of the monomer contained in the gel, the physical adhesion between the gel and the support can be increased, compared with the case where the support is just hydrophilized, and the affinity between the gel and the support can be improved, compared with the case where the support is just hydrophilized. This inhibits the detachment of the gel from the support, thus easily forming the gel in a predetermined region of the support.

In addition, for example, a covalent bond may be formed between the surface treatment compound and the gel to produce very high adhesion. Furthermore, for example, a monomer deposited on the support may be subjected to polymerization triggered by the surface treatment compound that has been radicalized, thereby suitably forming the gel.

According to the foregoing structure, the chip for electrophoresis holds the gel easily and appropriately as described above.

In the chip for electrophoresis according to the present invention, preferably, the gel is a polyacrylamide gel, and the surface treatment compound contains a vinyl compound. The vinyl compound, the foregoing vinyl compound, is more preferably a compound represented by the structural formula CH₂═CH—CONHR¹ (where R¹ represents —CH₂CH₂SO₃H, —CHOHCOOH, —(CH₂)ₙCH₂COOH (n=1 to 3), —(CH₂)ₙC₄H₈ON (n=2 or 3), —(CH₂)ₙC₄H₈SN (n=2 or 3), —(CH₂)ₙNH₂ (n=2 or 3), —(CH₂)₃N(CH₂CH₃)₂, or —(CH₂)₃NH₃⁺) or the structural formula CH₂═CHCOC₄H₉N₂.

According to the foregoing structure, the polyacrylamide gel is useful as an electrophoresis medium for use in two-dimensional electrophoresis and so forth by imparting a pH gradient, a concentration gradient, or the like thereto. Thus, the polyacrylamide gel is suitably used as a gel included in the chip for electrophoresis. The surface treatment compound is a monomer or a derivative of the monomer contained in the polyacrylamide gel. This results in an increase in the adhesion between the gel and the support and improvement in the affinity between the gel and the support.

In the chip for electrophoresis according to the present invention, preferably, the gel is an agarose gel, and the surface treatment compound contains a monosaccharide. The monosaccharide is more preferably a monosaccharide selected from the group consisting of galactose and anhydrogalactose.

According to the foregoing structure, agarose is useful as an electrophoresis medium and thus is suitably used as a gel included in the chip for electrophoresis. The surface treatment compound is a monosaccharide of a monomer or a derivative of the monomer contained in the agarose gel. This results in an increase in the adhesion between the gel and the support and improvement in the affinity between the gel and the support.

In the chip for electrophoresis according to the present invention, preferably, the surface treatment compound is covalently bonded to the gel.

According to the foregoing structure, the covalent bond between the surface treatment compound and the gel results in very high adhesion. In particular, in the case where the gel is formed by subjecting the monomer deposited on the support to polymerization triggered by the surface treatment compound, a reaction activity field for the polymerization is uniformly distributed on a two-dimensional plane, thereby improving the quality of the film of the gel.

In the chip for electrophoresis according to the present invention, the gel is preferably formed so as to protrude from the support.

According to the foregoing structure, the improved affinity and adhesion between the gel and the support result in the successful formation of the gel that protrudes from the support. The formation of the gel that protrudes from the support facilitates the application of a sample to be subjected to electrophoresis and eliminates the need for the formation of a channel in the support, thereby simplifying the structure of the support.

A method for producing a chip for electrophoresis according to the present invention, the chip for electrophoresis including a gel composed of a polymer prepared by polymerizing a monomer, and a support configured to support the gel, includes a covering step of covering at least part of a surface of the support with a surface treatment compound containing the monomer or a derivative of the monomer, and a gel formation step of forming the gel on a covered region of the surface of the support.

According to the foregoing configuration, it is possible to increase the adhesion between the gel and the support and improve the affinity between the gel and the support. That is, by covering the support with the monomer or the derivative of the monomer contained in the gel, the physical adhesion between the gel and the support can be increased, compared with the case where the support is just hydrophilized, and the affinity between the gel and the support can be improved, compared with the case where the support is just hydrophilized. This inhibits the detachment of the gel from the support, thus easily forming the gel in a predetermined region of the support. In addition, for example, a covalent bond may be formed between the surface treatment compound and the gel to produce very high adhesion. According to the foregoing configuration, as described above, it is possible to suitably produce the chip for electrophoresis, the chip holding the gel easily and appropriately.

In the method for producing a chip for electrophoresis according to the present invention, in the gel formation step, the gel may be formed by depositing the monomer on the region and polymerizing the monomer.

According to the foregoing configuration, the gel is formed by subjecting the monomer deposited on the support to polymerization triggered by the surface treatment compound; hence, a reaction activity field for the polymerization is uniformly distributed on a two-dimensional plane, thereby improving the quality of the film of the gel.

In the method for producing a chip for electrophoresis according to the present invention, in the gel formation step, a gel formation solution to form the gel may be ejected onto the region with an ink jet nozzle.

According to the foregoing configuration, it is possible to easily produce the uniform chip for electrophoresis with good productivity by an ink jet printing technique. In particular, it is possible to form a gel having a pH gradient or a concentration gradient.

In the method for producing a chip for electrophoresis according to the present invention, in the covering step, the surface treatment compound is preferably subjected to graft polymerization on the support.

According to the foregoing configuration, the use of the graft polymerization enables the formation of a surface treatment compound thin film controlled at a monolayer level on a surface of the support, thereby reducing variations in covering.

### INDUSTRIAL APPLICABILITY

The present invention is usable in the field of the production of analyzers for biological samples and so forth.

### Reference Signs List

1 substrate (support)

2 gel adhesion region

4 surface treatment compound

8 gel formation solution

9 gel

10 chip for electrophoresis

20 ink jet head

1. A chip for electrophoresis, comprising:
a gel composed of a polymer prepared by polymerizing a monomer; and a support configured to support the gel,
wherein a surface of the support in contact with the gel is covered with a surface treatment compound containing the monomer or a derivative of the monomer,
the gel is an agarose gel, and
the surface treatment compound contains a monosaccharide.

2.-4. (canceled)

5. The chip for electrophoresis according to claim 1, wherein the monosaccharide is a monosaccharide selected from the group consisting of galactose and anhydrogalactose.

6. The chip for electrophoresis according to claim 1, wherein the surface treatment compound is covalently bonded to the gel.

7. The chip for electrophoresis according to claim 1, wherein the gel is formed so as to protrude from the support.

8. A method for producing a chip for electrophoresis, the chip including a gel composed of a polymer prepared by polymerizing a monomer, and a support configured to support the gel, the method comprising:
a covering step of covering at least part of a surface of the support with a surface treatment compound containing the monomer or a derivative of the monomer; and
a gel formation step of forming the gel on a covered region of the surface of the support,
wherein in the gel formation step, a gel formation solution to form the gel is ejected onto the region with an ink jet nozzle.

9.-10. (canceled)

11. The method for producing a chip for electrophoresis according to 8, wherein in the covering step, the surface treatment compound is subjected to graft polymerization on the support.
